(19) United States
(12) Patent Application Publication
(10) Pub. No.: US 2024/0075498 A1
(43) Pub. Date: Mar. 7, 2024

(54) ONE COMPONENT, UV-CURED PRIMER MATERIAL FOR REPAIRING SURFACE IMPERFECTIONS

(71) Applicant: Illinois Tool Works Inc., Glenview, IL (US)

(72) Inventors: Mehdi Habibpour, Glenview, IL (US); Rick Turpin, Glenview, IL (US); Carlton Seaboldt, Glenview, IL (US); Grant Shouldice, Glenview, IL (US)

(73) Assignee: Illinois Tool Works Inc., Glenview, IL (US)

(21) Appl. No.: 18/238,604

(22) Filed: Aug. 28, 2023

Related U.S. Application Data
(60) Provisional application No. 63/403,060, filed on Sep. 1, 2022.

(51) Int. Cl. B05D 5/00; B05D 7/00; B05D 7/14

(52) U.S. Cl. CPC B05D 5/005; B05D 7/14; B05D 7/538; B05D 2503/00; B05D 2508/00; B05D 2601/00

(57) ABSTRACT

A method for repairing surface imperfections on a vehicle body includes the application of an uncured layer to a thickness of up to 0.254 mm of a primer composition comprising: a polyester resin, an acrylated urethane resin, a crosslinking agent, a solvent, and a particulate filler to the vehicle body. The uncured layer is exposed to actinic radiation to induce cure of the uncured layer to form a coating to fill the surface imperfection on the vehicle body. A surface coating primer composition is also provided that includes a polyester resin; an acrylated urethane oligomer or polymer; a crosslinking agent; a solvent; a photoinitiator; and a particulate filler. The uncured composition has a viscosity of between 100 and 800 centipoise.

### RELATED APPLICATIONS

This application is a non-provisional application that claims priority benefit of U.S. Provisional Application Ser. No. 63/403,060 filed 1 Sep. 2022; the contents of which are hereby incorporated by reference.

### FIELD OF THE INVENTION

The present invention in general relates to unsaturated curable composition for vehicle body repair that cures with ultraviolet (UV) light, and in particular to curable primer composition used in repairing imperfections on surfaces of auto-body repair coatings.

### BACKGROUND OF THE INVENTION

Body filler compositions are used in the vehicle repair aftermarket industry to repair of deformities such as holes and dents in vehicle bodies. The filler composition cures following application to the deformity and upon reaching a level of hardness, the resulting coating overlying the defect is sanded and finished with suitable painting steps to affect the repair of the vehicle body.

A primer is often used to adhere to a damaged vehicle surface and assure adhesion of subsequently applied layer such as paint layers that are needed to achieve the class A, high sheen surface finish common to exterior, new vehicle surfaces. The ability to control viscosity and cure to avoid pinhole formation would eliminate several remedial steps.

Conventional surface repair compositions are often two part systems that cure under free radical conditions. Mixing errors and ambiguity as to when a repair has reached a sufficient hardness to allow for sanding are common reasons why these remedial repairs must be repeated. The limited working time for a composition once mixing and cure have begun can also lead to rushed efforts to affect a repair. Furthermore, it is commonly believed in the art that pinholes are associated with solvent degassing as a composition cures, the high solvent loadings at the expense of inert filler particulate content associated with these conventional surface repair compositions is a reason pin hole repair is needed.

Thus, there exists a need for improved compositions that address the limitations of the prior art through resort to a one part, UV curable primer composition that inhibits pinhole formation. There further exists a need for a method of using such a composition that is UV curable and visually indicates when the primer composition has achieved a hardness sufficient to sand, if needed.

### SUMMARY OF THE INVENTION

A method for repairing surface imperfections on a vehicle body includes the application of an uncured layer to a thickness of up to 0.254 mm of a primer composition comprising: a polyester resin, an acrylated urethane resin, a crosslinking agent, a solvent, and a particulate filler to the vehicle body. The uncured layer is exposed to actinic radiation to induce cure of the uncured layer to form a coating to fill the surface imperfection on the vehicle body.

A surface coating primer composition is also provided that includes a polyester resin; an acrylate urethane oligomer or polymer; a crosslinking agent; a solvent; a photoinitiator; and

A particulate filler. The uncured composition has a viscosity of between 100 and 800 centipoise.

### DETAILED DESCRIPTION OF THE PREFERRED EMBODIMENTS

The present invention has utility as an ultraviolet (UV) light curable primer composition that is well suited for curing to form a coating directly on a vehicle exterior or a coated vehicle exterior. The resulting coating being amenable to overcoating with substances functioning as topcoats, primers, or paints. The present invention affords a user advantages in terms eliminating the need for pinhole revision after common to conventional coating compositions. The uncured inventive primer composition contains up to 45 total volume percent fillers thereby improving flow and sanding characteristics upon cure. Through resort to a one-part, UV curable primer composition mixing errors and unlimited working time are provided with a rapid cure once UV cure is initiated. An inventive primer composition achieves thicknesses of up to 0.254 millimeters (mm). In other embodiments in which a color change agent is present, a user has a visual cue as to when the primer composition has achieved sufficient hardness to sand so as eliminate yet another deficiency of prior art systems.

As used herein, “sandable” with reference to a cured inventive primer composition is defined as having limited clogging of sandpaper and able to form featheredge.

Embodiments of the inventive primer compositions provide UV curing coatings utilizing photo polymerization reactions using a variety of light sources such as low energy consuming and environmentally-friendly ultraviolet light emitting diode (UV-LED), older mercury or xenon arc lights, or simply sunlight. Absent UV exposure, an inventive primer composition has a working time that is longer than conventional two-part, peroxide cured coating system and is effectively infinite, yet cures more rapidly upon UV exposure thereby offering a user a controlled working time and a rapid cure thereafter. As a result, the applied material can be corrected or reworked without the conventional problem of viscosity build. Also, the UV cure of the inventive primer composition reduces temperature dependency of cure rates compared to conventional surface defect repair systems.

Numerical ranges cited herein are intended to recite not only the end values of such ranges but the individual values encompassed within the range and varying in single units of the last significant FIGURE. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

Table 1 lists the major components of an embodiment of the inventive curable primer composition.

TABLE 1
Composition of a UV curable vehicle
body repair primer composition

| | Typical Total Weight | Preferred Total Weight |
|---|---|---|
| Ingredient | Percent | Percent |
| Polyester resin | 20-50 | 23-38 |
| Acrylated urethane resin | 3-20 | 3-10 |
| Crosslinking agent | 0.1-10 | 0.1-8.2 |
| Photoinitiator | 0.1-5 | 0.1-1.8 |
| Anti-oxidant | 0-6 | 0.1-1.0 |
| Solvent | 5-30 | 8-19 |
| Additives | 0-12 | Each: 0.1-12 |
| Filler (e.g. pigment, | Remainder | Remainder (up to 45 |
| talc, microspheres) | | volume percent) |

An inventive polyester resin has a degree of ethylenic unsaturation that is between 20 and 100% of the non-alcoholic monomer in the polyester resin and denotes reactivity within the polyester resin backbone to free radical polymerization. The unsaturation in a polyester backbone is reactive with vinyl and allyl moieties of a styrenic or non-styrenic molecule through free-radical polymerization.

In some embodiments, an inventive unsaturated polyester resin is terminally functionalized with molecules illustratively including allyl glycidyl ether, glycidyl methacrylate, trimethylolpropane diallyl ether, allyl pentaerythritol or polymeric allyl glycidyl ether.

An inventive unsaturated polyester is readily formed in a single reaction or in multi-stage reactions. Typical reaction temperatures range from 130-240° C. A conventional esterification catalyst is present and illustratively includes acids, transition metal catalysts and organo-tin compounds. Typical catalyst loadings range from 0.01 to 1 total weight percent of the reactants.

Reactive polyester resins used in a primer composition for repairing imperfections on surfaces of auto-body repair coatings have a weight average molecular average weight ranging from 5,000 to 600,000, as determined by gas permeation chromatography (GPC). For purposes of calculating monomer percent, reactive diluents are omitted. Based polyester resin compositions operative herein are detailed in Table 1.

To form a primer composition for repairing imperfections on surfaces of auto-body repair coatings, the resulting reactive polyester resin is dissolved in a multifunctional reactive diluent. Reactive diluents operative herein include acrylics, acrylates, and methacrylates such as methyl methacrylate, butyl acrylate, ethyl-hexyl acrylate, hydroxpropyl methacrylate, hydroxethyl methacrylate, lauryl acrylate, stearyl methacrylate, lauryl methacrylate, butanediol diacrylate, ethyleneglycol dimethacrylate, ethyleneglycol-DCPD methacrylate, ethyl(meth)acrylate and n- and isobutyl(meth)acrylate, cyclohexyl(meth)acrylate, isobornyl(meth)acrylate, benzyl(meth)acrylate, butyleneglycol dimethacrylate, diethyleneglycol dimethacrylate, triethyleneglycol dimethacrylate, propyleneglycol dimethacrylate, dipropyleneglycol dimethacrylate, dipropyleneglycol diacrylate, tripropyleneglycol dimethacrylate and trimethylolpropane triacrylate, or DCPD diacrylate; ether monomers of the structure (C₁-C₆ alkyl)-O—(C₂-C₆ alkylene) such as ethyl vinyl ether, or methyl vinyl; styrene, α-methylstyrene, vinyl toluene, di-functional styrene, allyl substituted benzene, di-vinyl benzene, di- and trifunctional acrylates (commercially available for example as SARTOMER® and MIRAMAR® products), acrylonitrile, mono-vinyl-terminated polydimethylsiloxanes, and combinations of any of the aforementioned. It should be appreciated that a phenyl ring having two moieties in the aforementioned list is intended to include ortho isomers, para isomers, meta isomers, and isomeric mixtures of each. Typical loadings of polyester resin in an inventive primer composition are from 20 to 50 total weight percent of a fully formulated primer composition.

An actinic radiation curable resin is also present in some embodiments of an inventive primer composition in the form of an acrylated urethane oligomer or polymeric resin. Such resins are readily formed from polyether polyol, a diisocyanate and hydroxyethyl acrylate. The resin typically has a number average molecular weight of 1,000 to 20,000 Daltons as measure by GPC. Diisocyanates operative herein illustratively include dicyclohexyl methane diisocyanate, isophorone diisocyanate. It is appreciated that aliphatic urethane acrylate resins are typically sold commercially as a 60 to 85% by weight in a diluent such as trimethylolpropane triethoxy triacrylate, pentaerythritol tri/tetracrylate, or the like. Still other actinic radiation curable resins operative herein are detailed in U.S. Pat. No. 5,908,873. Typical loadings of acrylated urethane in an inventive primer composition are from 3 to 20 total weight percent of a fully formulated primer composition.

A crosslinking agent that is multifunctional is also present in an inventive primer composition. As used herein, multifunctional is defined as a compound that has a polymerizable functionality of at least 2. Difunctional crosslinking agents are particularly well suited for use in the present invention. Crosslinking agents operative in the present invention illustratively include diallyl fumarate, diallyl diglycol carbonate, allyl methacrylate, isobornyl acrylate, diallyl phthalate, diallyl suberate, diallyl tetrabromophthalate, diethylene glycol diacrylate, diethylene glycol dimethacrylate, diethylene glycol divinyl-ether, N,N′-dimethacryloylpiperazine, 2,2-dimethylpropanediol dimethacrylate, dipentaerythritol pentaacrylate, dipropylene glycol dimethacrylate, di-trimethylolpropane tetraacrylate, divinyl glycol, divinyl sebacate, glycerol trimethacrylate, 1,5-hexadiene, 1,6-hexanediol diacrylate, 1,6-hexanediol dimethacrylate, N,N′-methylenebismethacrylamide, 1,9-nonanediol dimethacrylate, pentaerythritol tetraacylate, pentaerythrtol triacrylate, pentaerythritol triallyl ether, 1,5-pentanediol dimethacrylate, poly(propylene glycol) dimethacrylate, tetraethylene glycol dimethacrylate, triethylene glycol diacrylate, triethylene glycol dimethacrylate, dipropylene glycol diacrylate, triethylene glycol divinyl ether, 1,1,1-trimethylolethane trimethacrylate, 1,1,1-trimethylolpropane diallyl ether, 1,1,1-trimethylolpropane triacrylate, 1,1,1-trimethylolpropane trimethacrylate, tripropylene glycol diacrylate, 1,2,4-trivinylcyclohexane, divinyl benzene, bis(2-methacryloxyethyl)phosphate, 2,2-bis(4-methacryloxyphenyl)propane, 1,3-butanediol diacrylate, 1,4-butanediol diacrylate, 1,3-butanediol dimethacrylate, 1,4-butanediol dimethacrylate, 1,4-butanediol divinyl ether, 1,4-cyclohexanediol dimethacrylate, bis[4-(vinyloxy)butyl]isophthalate, bis[4-(vinyloxymethyl)cyclohexylmethyl]glutarate, bis[-(vinyloxy)butyl]succinate, bis((4-((-vinyloxy)methyl)cyclohexyl)methyl)isophthalate, bis(4-(vinyloxy)butyl)terephthalate, bis[[(4-[vinyloxy)methyl)cyclohexyl]methyl]terephthalate, bis[4-vinyloxy)butyl]adipate, bis[4-(vinyloxy)butyl](methylenedi-1,4-phenylene)biscarbamate, bis-[4-(vinyloxy)butyl](4-methyl-1,3-phenylene)biscarbamate, bis[4-(vinyloxy)butyl]1,6-hexanediylbiscarbamate, tris[4-(vinyloxy)butyl]trimellitate or combinations thereof. It is appreciated that a minority amount of trifunctional or higher functional crosslinking agent present modifies the cured coating properties. It is appreciated that a reactive diluent, the crosslinking agent, or the combination thereof are operative in curing and also serves to reduce the viscosity of the under ambient temperature and pressure application conditions of Standard Temperature and Pressure (STP) and without appreciable degassing as the reactive diluents and crosslinking agents are cured into the final solid, cured coating. Typical loadings of crosslinking agent in an inventive primer composition are from 0.1 to 10 total weight percent of a fully formulated primer composition.

In order to achieve enhanced rates of actinic cure, a photoinitiator is present from 0.1 to 5 total weight percent. Bisacylphosphine oxides (BAPO) are exemplary of a photoinitiator operative in the present invention. Specific bisacylphosphine oxides operative herein illustratively in phenyl bis(2, 4, 6-trimethylbenzoyl)-phosphine oxide, diphenyl(2,4,6-trimethylbenzoyl)phosphine oxide, bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-ethoxyphenylphosphine oxide, bis-(2,6-dichlorobenzoyl)-4-biphenylylphosphine oxide, bis-(2,6-dichlorobenzoyl)-4-propylphenylphosphine oxide, bis-(2,6-dichlorobenzoyl)-2-naphthylphosphine oxide, bis-(2,6-dichlorobcnzoyl)-1-napthylphosphine oxide, bis-(2,6-dichlorobenzoyl)-4-chlorophenylphosphine oxide, bis-(2,6-dichlorobenzoyl)-2,4-dimethoxyphenylphosphine oxide, bis-(2,6-dichlorobenzoyl)decylphosphine oxide, bis-(2,6-dichlorobenzoyl)-4-octylphenylphosphine oxide, bis-(2,6-dimethoxybenzoyl)-2,5-dimethylphenylphosphine oxide bis-(2,6-dimethoxybenzoyl)phenylphosphine oxide, bis-(2,4,6-trimethylbenzoyl)-2,5-dimethylphenylphosphine oxide, bis-(2,6-dichloro-3,4,5-trimethoxybenzoyl)-2,5-dimethylphenylphosphine oxide, bis-(2,6-dichloro-3,4,5-trimethoxybenzoyl)-4-ethoxyphenylphosphine oxide, bis-(2-methyl-1-naphthoyl)-2,5-dimethylphenylphosphine oxide, bis-(2-methyl-1-naphthoyl)phenylphosphine oxide, bis-(2-methyl-1-naphthoyl)-4-biphenylphosphine oxide, bis-(2-methyl-1-naphthoyl)-4-ethoxyphenylphosphine oxide, bis-(2-methyl-1-naphthoyl)-2-naphthylphosphine oxide, bis-(2-methyl-1-naphthoyl)-4-propylphenylphosphine oxide, bis-(2-methyl-1-naphthoyl)-2,5-dimethylphosphine oxide, bis-(2-methoxy-1-naphthoyl)-4-ethoxyphenylphosphine oxide, bis-(2-methoxy-1-naphthoyl)-4-biphenylylphosphine oxide, bis-(2-methoxy-1-naphthoyl)-2-naphthylphosphine oxide, bis-(2-chloro-1-naphthoyl)-2,5-dimethylphenylphosphine oxide, and combinations thereof. Still other photoinitiators operative herein include mono-aryl ketones, and trimethylbenzoyldiphenyl phosphinates, with specific examples thereof illustratively including 1-hydroxycyclohexyl phenyl ketone, 2-hydroxy-2-methyl-1-phenyl-propan-1-one, ethyl-2,4,6-trimethylbenzoylphenyl phosphinate In some inventive embodiments, liquid blends of photoinitiators are provided by dissolving solid bisacylphosphine oxide photoinitiator in another liquid photoinitiator or a photoinitiator blend which is of liquid form.

In some inventive embodiments, an anti-oxidant is present in a UV curable coating primer composition and without intending to be bound to a particular theory is believed to function as a cure inhibitor to mitigate premature cure. An antioxidant operative herein illustratively includes butylated hydroxyanisole, 2,6-di-ter-butyl cresol, 2,2′-methylene bis(6-t-butyl-4-methyl phenol), 2,2′-thio bis(6-t-butyl-4-methyl phenol), tert-butyl hydroquinone, di-tert-butyl hydroquinone, di-tert-amyl hydroquinone, methyl hydroquinone, p-methoxy phenol, tetrakis[methylene-3-(3′,5′-di-tert-butyl-4′-hydroxyphenyl)propionate]methane, N-(2-aminoethyl)-3-[3,5-bis(tert-butyl)-4-hydroxyphenyl]propanamide, 5,7-di-tert-butyl-3-(3,4,-dimethylphenyl)-3H-benzofuran-2-one, dilauryl thiodipropionate, dimyristyl thiodipropionate, tris(nonylphenyl) phosphite, and combinations thereof. Typical loadings of an anti-oxidant in an inventive primer composition are from 0 to 6 total weight percent of a fully formulated primer composition.

To further control viscosity and while not intending to be bound by theory, it is believed that solvents can be effective as a dispersive vehicle for the fillers and resins in an inventive primer composition prior to curing, yet without inducing pinholes upon cure. During the application of the primer composition, solvents aid in achieving an appropriate viscosity of the primer composition. However, after the coating has been cured, it can be expected that there is less than 0.1% of the solvent to no detectable residual solvent. Solvents operative herein illustratively include hydrocarbons, alcohols, polyols, ketones, ethers, and pyrrolidinones, subject to the proviso that the solvent has a molecular weight of less than 300 Daltons. Examples of hydrocarbons operative herein illustratively include Stoddard solvent, toluene, xylene, naphtha, petroleum distillates, ethyl benzene, trimethyl benzenes, and fractions of hydrocarbon mixtures obtained from petroleum refineries. Alcohols operative herein illustratively include ethanol, n-propanol, iso-propanol, n-butanol, iso-butanol, benzyl alcohol, 2-(n-propoxy)ethanol, 2-(n-butoxy)ethanol, 3-(n-propoxy)ethanol, and 2-phenoxyethanol. Ketones operative herein illustratively include acetone, methyl ethyl ketone, methyl n-propyl ketone, methyl n-butyl ketone, methyl amyl ketone, and methyl isoamyl ketone. Esters operative herein illustratively include ethyl propanoate, ethyl butanoate, ethyl glycolate, propyl glycolate, butyl glycolate, and isoamyl glycolate, methyl acetate, ethyl acetate, n-butyl acetate, isoamyl acetate, and t-butyl acetate. Glycols operative herein illustratively include ethylene glycol and polypropylene glycol. Glycol ethers operative herein illustratively include propylene glycol monomethyl ether and ethylene glycol monobutyl ether. Pyrrolidinones operative herein illustratively include 1-methyl-2-pyrrolidinone and 1-ethylpyrrolidin-2-one. Mixtures of any two or more of these solvents may also be utilized. Mixtures of miscible combinations of any of the aforementioned are also appreciated to be operative herein. Solvent is typically present in an inventive primer composition from 5 to 30 weight percent.

Several additives are readily included in an inventive primer composition that illustratively include corrosion inhibitors, flow control additives, a color changing dye indicative of extent of cure, pigments and dyes and combinations thereof. A color changing dye indicative of the extent of cure is detailed in US2020/0239710A1. Generally, each of the aforementioned additives is independently present from 0 to 12 total weight percent.

Filler particulates or fibers operative in the present invention illustratively include talc, alumina trihydrate, calcium sulfate, calcium carbonate, magnesium sulfate, magnesium carbonate, barium sulfate, microspheroids and the like. A filler is present as the remainder total weight percent of a complete primer composition for application to a substrate, with a typical upper limit being 45 volume percent of the uncured primer composition. It is appreciated that a pigment and filler can have the same function and in those instances where both are present in a primer composition, the amounts of both are cumulative.

As used herein a microspheroid is defined to include a hollow microsphere or a solid bead having an aspect ratio of between two normal maximal linear dimensions of between 1 and 1.6. Typically, a spheroid particle is formed of glass or a thermoplastic material. In some inventive embodiments, the microspheroid is within 10 linear dimension percent of spherical and formed of glass. A microspheroid typically has a longest linear dimension of between 20 and 100 microns to improve sandability and reduce density.

It is appreciated that the primer composition is readily be reapplied as many times as necessary, either before or after initiation of cure to fill surface imperfections. Each application being by applied by brushing, spraying, wiping, or blade spreading. Typical viscosities of an inventive primer composition fully formulated range from 100 to 800 Centipoise, as measured by tube viscosity measurement.

The UV radiation necessary for curing can be provided from several sources, including mercury arc lamps, xenon arc lamps, and UV-light emitting diodes (UV-LED). Because of the lower consumption of energy, and reduced heating of the substrate, UV-LED curing is often a preferred actinic radiation source for curing relative to a mercury arc lamp. The UV-LED bulbs do not generate ozone, in contrast to the typical UV-bulbs, require less energy, and exhibit a longer lifetime. The absence of mercury also promotes ease of disposal. UV LEDs emissions a 365 nm, 385 nm, 395 nm, and 405 nm, are each alone or in combination suitable for inducing cure of an inventive primer composition. Typical rates of cure for an inventive primer composition is 0.3 to 2 minutes for 1 mm thick composition.

The present invention is further detailed with respect to the following non limiting examples. These examples are not intended to limit the scope of the invention but rather highlight properties of specific inventive embodiments and the superior performance thereof relative to comparative examples.

### EXAMPLES

### Example 1

An inventive primer composition is provided based on a polyester resin (29 total weight percent), acrylated urethane resin (7.5 total weight percent), a crosslinking agent of dipropylene glycol diacrylate (2.5 total weight percent), a TPOL photoinitiator (CAS: 84434-11-7, 1.3 total weight percent), solvent (14 total weight percent), a corrosion inhibitor mixture of zinc oxide 18 percent and trizinc bis(orthophosphate) 40 weight percent in a water suspension (10 total weight percent), and the remainder being 24 micron talc particulate filler. The inventive primer composition flowed onto an automotive vehicle exterior defect to a thickness of 0.254 mm. After exposure to actinic radiation from a UV-LED at 395 nm for 300 seconds, the sanded substrate with an inventive cured coating is free of pinholes as measured with an unaided, normal human eye.

### Example 2

The process of Example 1 is repeated with the acrylated urethane resin present at 15 total weight percent instead of 7.5 total weight percent of Example 1. A similar cure profile results.

### Example 3

The process of Example 1 is repeated with the polyester resin present at 18 total weight percent instead of 29 total weight percent of Example 1. A similar cure profile results.

### Example 4

The process of Example 1 is repeated with color changing Red Dye FR-1 per US2020/0239710A1 present at 0.1 total weight with a like amount reduction in the amount of solvent of Example 1. A similar cure profile results and a color change occurs within 5 minutes of hardness to sand of the resulting coating.

### Comparative Examples

The process of Example 1 is repeated without acrylated urethane and dipropylene glycol diacrylate and the amount of the polyester resin increased by a like amount. The resulting layer is tacky at surface and the cure was incomplete.

The process of Example 1 is repeated without TPOL photoinitiator. The coated layer did not cure.

The process of Example 1 is repeated without dipropylene glycol diacrylate and styrene was added at 8.2 total weight percent. The coated layer did not fully cure and the surface was tacky.

These examples demonstrate the processes to be claimed in this patent filing. It should be remarked that other additions and modifications as known in the art are also expected to be covered.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A method for repairing surface imperfections on a vehicle body comprising:
applying an uncured layer to a thickness of up to 0.254 mm of a primer composition comprising: a polyester resin, an acrylated urethane resin, a crosslinking agent, a solvent, and a particulate filler to the vehicle body; and
exposing the uncured layer to actinic radiation to induce cure of the uncured layer to form a coating to fill the surface imperfection on the vehicle body.

2. The method of claim 1 further comprising applying an overlayer of a primer or paint on the coating.

3. The method of claim 1 wherein the actinic radiation is emission from an ultraviolet light emitting diode.

4. The method of claim 1 wherein the primer composition has a viscosity of between 100 and 800 centipoise at standard temperature and pressure.

5. The method of claim 1 wherein the exposing is from 0 seconds to 300 seconds.

6. A coating formed by the method of claim 1 devoid of pinholes visible to an unaided, normal human eye with a thickness of up to 0.254 mm.

7. The coating of claim 6 having a thickness of up to 1 mm.

8. A surface coating primer composition comprising:
a polyester resin;
an acrylated urethane oligomer or polymer;
a crosslinking agent;
a solvent;
a photoinitiator; and
a particulate filler, and having an uncured viscosity of between 100 and 800 centipoise.

9. The primer composition of claim 7 further comprising an aliphatic urethane acrylate resin.

10. The primer composition of claim 7 wherein said multifunctional crosslinking agent resin is difunctional.

11. The primer composition of claim 7 wherein said multifunctional crosslinking agent resin is a diacrylate.

12. The primer composition of claim 7 wherein said multifunctional crosslinking agent resin is present from 0.1 to 10 total weight percent.

13. The primer composition of claim 7 wherein said particulate filler comprises at least one of talc, alumina trihydrate, calcium sulfate, calcium carbonate, magnesium sulfate, magnesium carbonate, barium sulfate, or microspheroids.

14. The primer composition of claim 7 further comprising at least one additive of corrosion inhibitors, flow control additives, a color changing dye indicative of extent of cure, pigments and dyes and combinations of any of the aforementioned.

15. The primer composition of claim 7 wherein each of the aforementioned additives is independently present up to 12 total weight percent.
